(19) United States
(12) Patent Application Publication
(10) Pub. No.: US 2009/0302131 A1
(43) Pub. Date: Dec. 10, 2009

(54) Spray Device for Fluids

(76) Inventor: Klaus Habr, Stuttgart (DE)

Correspondence Address: KENYON & KENYON LLP, ONE BROADWAY, NEW YORK, NY, 10004, US

(21) Appl. No.: 12/227,303

(22) PCT Filed: Apr. 11, 2007
(86) PCT No.: PCT/EP2007/053501

§ 371 Date: Mar. 24, 2009

(30) Foreign Application Priority Data
Jun. 6, 2006 (DE) 10 2006 026 153.4

(51) Int. Cl. B05B 9/00

(52) U.S. Cl. 239/142; 239/8

(57) ABSTRACT

A spray device for fluids having a nozzle and an actuator for regulating the fluid flow through the nozzle exit. In addition, a shock wave actuator or HIFU actuator is provided for generating shock waves or HIFU waves in the fluid present in the nozzle.

### FIELD OF THE INVENTION

The present invention relates to a spray device for fluids.

### BACKGROUND INFORMATION

German Patent Application No. DE 198 07 240 A1 describes an injection system for liquid fuels, in particular for a fuel oil burner, which includes a feed pump, a fluid reservoir, and an injection nozzle as well as pressure relief valves. The feed pump withdraws the liquid fuel from the fluid reservoir and feeds it to the injection nozzle while the pressure relief valves prevent an improper sharp rise in the system pressure. The injection time is varied for control of the injection quantity. For this purpose, additional hydraulic components are provided which make a pulsating operation possible. Pressure pulsations, whose frequency and pulse duration determine the fuel quantity to be injected, are generated with the aid of a rapidly opening and closing solenoid valve. During exit of the fuel from the nozzle exit borehole of the injection nozzle, an atomized spray, composed of small fuel droplets and air, is created, which is also referred to as aerosol. The advantage of this atomized spray is a better distribution in the combustion chamber, the drop size having an effect on the uniform dispersion. For generating small drops, high injection pressure is needed which requires great technical complexity to generate.

### SUMMARY

An object of the present invention is to provide a spray device using simple constructive measures which is characterized by reduced energy usage and at the same time by small drop sizes.

A spray device for fluids according to an example embodiment of the present invention is provided with a shock wave actuator via which shock waves are generated in the spray device which are then conveyed onto the fluid situated in the nozzle. The physical phenomenon of the shock wave is a strong pressure wave in elastic media such as fluids, for example, which propagates at a supersonic speed while high mechanical stresses and pressures prevail in the shock front of the shock wave. The shock wave represents a pressure pulse in which the pressure sharply rises and subsequently steeply plunges again within a split second. The extreme pressure change generated by the pressure wave is utilized for generating the atomized spray in the spray device according to the present invention by directing the shock wave energy to a focusing point at which the droplet formation takes place. The advantage of this procedure is that the average system pressure in the fluid may be kept relatively low and a spray having very small drop sizes may still be generated since the energy needed for the droplet formation originates from the shock wave and not from the system pressure. Compared to conventional designs, overall energy savings and constructive simplification are achieved here which result in particular from the use of the low-pressure system instead of the otherwise common high-pressure system. The shock wave may be precisely directed to a certain focusing point which is normally located at the nozzle exit where the exiting atomized spray is generated. The fluid is accelerated at the focusing point to supersonic speed so that there are optimum conditions for a drop size distribution having preferably small drops.

A further advantage is that the shock wave may be generated at a distance from the focusing point at a position in the spray device which is favorable from the construction point of view, in particular inside the nozzle housing at a distance to the nozzle exit. A wall section of the nozzle housing having a concave shape may be used as the shock wave actuator, for example, the concave shape supporting the precise dispersion of the shock wave in the direction of the focusing point. The dispersion from the position of the shock wave actuator in the nozzle housing to the focusing point takes place via the fluid situated in the nozzle as the wave carrier.

The shock waves are preferably generated with the aid of a piezoelectric element or a piezoelectric composite element which forms a wall section in the housing wall of the nozzle, for example. At least two shock wave actuators are advantageously provided whose shock waves intersect at the intended focusing point. Alternatively to piezoelectric elements, shock wave actuators may also be used which operate according to an electrohydraulic principle (spark discharge path) or according to an electromechanical power conversion principle.

Alternatively to the shock wave principle, piezoelectric elements or piezoelectric composite elements or other fast actuators may be used which operate according to the HIFU principle (High Intensity Focused Ultrasound). In this case, the shock wave is replaced by a high-frequency ultrasound source.

Focusing on the nozzle exit may be carried out directly as well as indirectly. In the event of direct focusing, the shock wave propagates directly between the shock wave actuator and the focusing point and in the case of indirect propagation the shock wave is first reflected on at least one reflection surface and is then conveyed in the direction of the focusing point. The advantages of indirect propagation are the greater choice in constructive design options for the arrangement of the shock wave actuator, so that very narrowly dimensioned spray devices may be implemented.

In order to generate the desired injection quantity per injection operation, it may be advantageous to generate multiple shock waves in short sequential intervals which are generated in high-frequency in particular. The quantity metered per injection operation is determined by the number of the consecutive shock wave pulses.

The described example spray device may be used in different types of products. Considered may be all types of injection systems, in particular injection systems in internal combustion engines such as diesel vehicles and gasoline vehicles; the injection of fluid solutions into the exhaust gas system of an internal combustion engine as exhaust gas treatment (ammonia injection) may also be considered. In addition, novel carburetor arrangements, in which such spray devices may be used, are also possible.

### BRIEF DESCRIPTION OF THE DRAWINGS

Additional advantages and advantageous example embodiments are described below.

FIG. 1 shows a section through a spray device including a nozzle which has concave walls which are designed as piezoelectric elements for generating shock waves, the shock waves being directed to the nozzle exit for generating an atomized spray.

FIG. 2 shows a spray device in an alternative design in which the shock waves are initially reflected on reflection surfaces, which delimit the nozzle interior, and are subsequently conveyed to the focusing point at the nozzle exit.

### EXAMPLE EMBODIMENTS OF THE PRESENT INVENTION

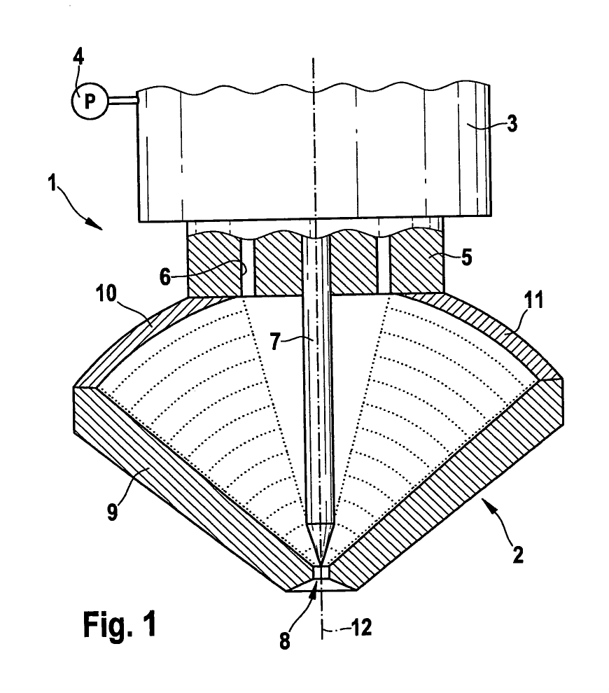

Spray device 1 shown in FIG. 1 is a fuel injection system for internal combustion engines, for example. Spray device 1 includes a nozzle 2 which is connected to a fluid reservoir 3 via a supply device 5 into which supply boreholes 6 are introduced. The fluid in fluid reservoir 3 is pressurized, in particular using only low pressure, via a pressure generating unit 4, designed as pump P as an example. In the exemplary embodiment, nozzle housing 9 has a funnel-shaped design; a nozzle exit 8 is situated at the tip of the nozzle housing which may be opened and closed by an actuator which is designed as valve needle 7. Valve needle 7 is guided axially displaceably and supported in supply device 5. Valve needle 7 is adjusted between its opening and closing positions as a function of instantaneous state and performance quantities of the system. Valve needle 7 moves along the valve needle longitudinal axis 12, this movement being generated with the aid of a suitable actuator.

The fuel is supplied from fuel reservoir 3 into the nozzle interior in nozzle housing 9 via supply boreholes 6 in supply device 5. For generating an atomized spray of fuel at nozzle exit 8, shock waves are generated in nozzle 2 which focus at nozzle exit 8 and transfer the shock wave energy at the nozzle exit to the fuel situated there, thereby creating fuel droplets which exit from the nozzle housing 9 via the nozzle exit and form an atomized fuel spray. The shock waves are generated by shock wave actuators 10 and 11 which form part of the wall of nozzle housing 9 facing nozzle exit 8. Shock wave actuators 10 and 11 are, for example, piezoelectric elements which change their shape when an electrical voltage is applied, the shape changing procedure taking place within very short periods. This shape change is directly transferred to the fluid present in the interior of nozzle housing 9, thereby generating the intended shock wave which moves toward nozzle exit 8. In order to increase the effect, the shock waves generated by the two shock wave actuators 10 and 11 move toward a mutual focusing point which is in nozzle exit 8. For supporting the focusing effect, both shock wave actuators 10 and 11 have a concave form, similar to a concave mirror, in such a way that the focal point is in nozzle exit 8.

As an alternative to the shock wave actuators based on the piezoelectric effect, actuators may also be used which operate according to the electrohydraulic principle or according to another electromechanical power conversion principle or the HIFU principle.

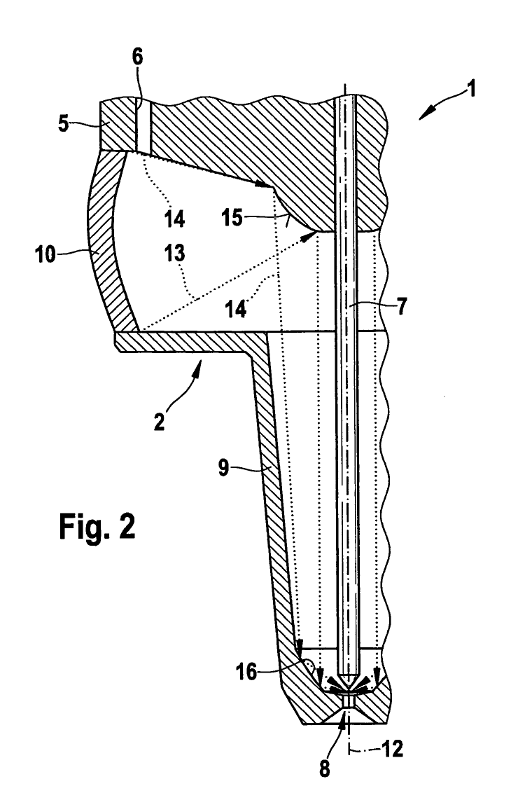

In the exemplary embodiment shown in FIG. 1, the shock waves move directly from the point of their generation, i.e., shock wave actuators 10 and 11, to the focusing point at nozzle exit 8 without redirection or reflection. An alternative example embodiment is shown in FIG. 2 where shock waves 13 and 14, depicted using dashed lines which mark the maximum emission angle range, are directed not directly but rather from the point of their generation at shock wave actuator 10 to the focusing point at nozzle exit 8 via multiple reflections. Shock wave actuator 10 is not situated directly opposite nozzle exit 8 but rather in a laterally positioned wall in nozzle housing 9 in a position without direct connection to the nozzle exit. This arrangement has the advantage of a narrowly dimensioned construction. In order to direct shock waves 13 and 14 to the focusing point at nozzle exit 8, the shock waves are redirected on reflection surfaces 15 and 16 which are interior walls of the nozzle housing delimiting the nozzle interior. In the exemplary embodiment, two reflection surfaces 15 and 16 are provided on which shock waves 13 and 14, emitted by shock wave actuator 10, are reflected, the shock waves of the same shock wave actuator hitting different reflection surfaces over the emission angle range generated by shock wave actuator 10. The multiple redirection of the shock waves basically allows greater constructive degrees of freedom with regard to positioning the shock wave actuators as well as with regard to the overall constructive design of spray device 1.

It is also possible to provide shock wave actuators whose shock waves, depending on the emission angle, are directed to the focusing point either directly or also indirectly via a single redirection or multiple redirections on reflection surfaces.

In order to generate the required energy for creating preferably small drops at nozzle exit 8 with the aid of the shock waves, the shock waves are advantageously generated repeatedly per injection-cycle, in particular at high frequency.

1-13. (canceled)

14. A spray device for fluids, comprising:
a nozzle;
an actuator for regulating the fluid flow through an exit of the nozzle; and
a shock wave or HIFU actuator adapted to generate shock waves or HIFU waves in fluid present in the nozzle.

15. The spray device as recited in claim 14, wherein the shock wave actuator or HIFU actuator is integrated into a housing of the nozzle.

16. The spray device as recited in claim 15, wherein the shock wave actuator or HIFU actuator forms a concave-shaped wall section of the nozzle housing.

17. The spray device as recited in claim 16, wherein the shock wave actuator or HIFU actuator is one of a piezoelectric element or a piezoelectric composite element.

18. The spray device as recited in claim 14, wherein the shock wave actuator or HIFU actuator is an electrohydraulic actuator.

19. The spray device as recited in claim 14, wherein the shock wave actuator or HIFU actuator is an electromechanical actuator.

20. The spray device as recited in claim 14, wherein shock waves or HIFU waves generated by the shock wave or HIFU actuator are focused on the nozzle exit.

21. The spray device as recited in claim 14, wherein the shock waves or HIFU waves generated by the shock wave actuator or HIFU actuator are reflected on a housing wall of the nozzle and directed to the nozzle exit.

22. The spray device as recited in claim 14, wherein the spray device includes at least two shock wave actuators or HIFU actuators whose shock waves or HIFU waves intersect at a mutual focusing point.

23. The spray device as recited in claim 14, further comprising:
a pressure generating unit adapted to pressurize the fluid.
HIFU wave sections are generated sequentially for metering fluid flow through the nozzle exit.

25. The spray device as recited in claim 24, wherein the spray device is an injection system for fluid fuels in an internal combustion engine.

26. A method for generating an atomized spray from a fluid, comprising:
directing a shock wave or HIFU wave onto the fluid at a defined focusing point.
